(19) United States
(12) Patent Application Publication
(10) Pub. No.: US 2008/0219860 A1
(43) Pub. Date: Sep. 11, 2008

(54) PROTECTION SYSTEM FOR AIR COMPRESSOR ASSEMBLY

(75) Inventors: VINCENT W. CAITO, POMONA, CA (US); HECTOR RAY HERNANDEZ, FULLERTON, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: ALLTRADE TOOLS LLC, LONG BEACH, CA (US)

(21) Appl. No.: 11/683,979

(22) Filed: Mar. 8, 2007

(51) Int. Cl. F04B 53/00; B23P 17/00

(52) U.S. Cl. 417/234; 29/888

(57) ABSTRACT

An air compressor assembly is described for providing compressed air to work tools and the like. The compressor assembly is surrounded by a frame structure made from elements of tubular stock. The frame structure is used for storing compressed air produced by the compressor assembly. In a novel and inventive aspect of the device, the frame structure is coated with a layer of PVC which in a preferred embodiment may be 3 mm to 7 mm thick.

### BACKGROUND OF THE INVENTION

This invention relates to power operated air compressor assemblies and more particularly to power operated air compressor assemblies of the portable type suitable for use in operating pneumatically actuated tools.

Power operated air compressor assemblies are well known in the art. It is known in the art for some assemblies to comprise a frame structure that provides a structural support and protection for a power operated air compressor unit operated to compress air into a container. This container is a source of compressed air for operating driving tools and the like.

Typically, the power operated air compressor unit is an off the shelf item comprising a conventional air compressor of any known construction, as, for example, a reciprocating piston type compressor having a suitable prime mover drivingly connected thereto as, for example, an electric motor or an internal combustion engine. Other off the shelf items utilized may include various control valves, air tubes and air pressure gauges. Similarly, the container may be an off the shelf item, typically one or two cylindrical tanks.

In some compressor assemblies, however, the frame structure may be made of tubular stock, internally interconnected between the various components to provide a continuous internal chamber, and this tubular structure may itself be the reservoir for holding the compressed air.

However, problems and shortcomings exist in the prior art. In those compressor assemblies where a frame unit is provided to surround the compressor unit and other items, as both a protective outer framework and a container, or reservoir, for compressed air, it is commonly found that vibration of the frame assembly is a problem, causing noise and physical vibration to the detriment of the surrounding environment and also to the life span of the assembly itself. Heating and cooling of the chamber, resulting from rapidly venting and filling the chamber, requires the compressor assembly to act, in part, as a heat exchanger, and considerable energy and efficiency may be lost in performing this function. Moreover, the environments in which compressor assemblies typically operate are aggressive and corrosive, in which the assembly may sustain knocks and bumps, and be subject to corrosive chemical exposure.

Accordingly, there is a need for a compressor assembly that overcomes the described shortcomings. The present invention addresses these and other needs.

### SUMMARY OF THE INVENTION

According to a preferred embodiment of the invention, there is described a compressor assembly suitable for use in harsh environments, with improved efficiency. In a preferred embodiment, the compressor assembly comprises an air compressor for providing a stream of compressed air. A reservoir for receiving and storing the stream of compressed air is provided, wherein the reservoir comprises a hollow tubular structure defining an enclosed space configured such that the tubular structure forms a frame to generally surround an external perimeter of the compressor assembly. In an important aspect of the invention, the tubular structure is coated with a layer of PVC, preferably, between 3 and 7 mm thick. Arising from the method of manufacture, the PVC coating covers essentially the entire surface of the tubular structure. In a preferred embodiment, the PVC coating is low density PVC. Thus, the PVC coating has been found to provide advantageous attenuation against vibration, improves the thermal efficiency of the assembly, and provides resistance against aggressive and corrosive environments.

In another aspect of the invention, a method is described for manufacturing a compressor assembly that includes an air compressor for providing a stream of compressed air. The method includes forming a tubular structure to define a continuous enclosed space, with the tubular structure being configured to surround and support internal components of the compressor assembly. An oven is heated, and the tubular structure is inserted in the oven for heating. After heating, the tubular structure is removed from the oven, and dipped in a tank of liquid PVC. Thereafter, the tubular structure is removed from the liquid PVC, and the PVC is allowed to cure to a hardened state. The air compressor, along with other components of the assembly, is then connected to the tubular structure to form the compressor assembly. In preferred aspects of the invention, heating the oven includes heating the oven to between 300 and 350 Celsius, and inserting the tubular structure in the oven includes holding the tubular structure in the oven for between 5 and 10 minutes. Again preferred, dipping the tubular structure in liquid PVC includes holding the tubular structure in liquid PVC for between 15 and 30 seconds, and allowing the PVC to cure includes maintaining the tubular structure in an enclosure at above 100 degrees. Finally preferred, maintaining the tubular structure in an enclosure includes maintaining the tubular structure in an enclosure for more than 3 minutes.

These and other advantages of the invention will become more apparent from the following detailed description thereof and the accompanying exemplary drawings.

### BRIEF DESCRIPTION OF THE DRAWINGS

FIG. 1 a front elevation perspective view of a power operated air compressor assembly embodying the principles of the present invention;

FIG. 2 is a side elevation perspective view of the assembly shown in FIG. 1;

FIG. 3 is a top elevation perspective view of the assembly shown in FIG. 1; and

FIG. 4 is a sectional view taken substantially along line A-A in FIG. 3.

### DETAILED DESCRIPTION OF THE PREFERRED EMBODIMENTS

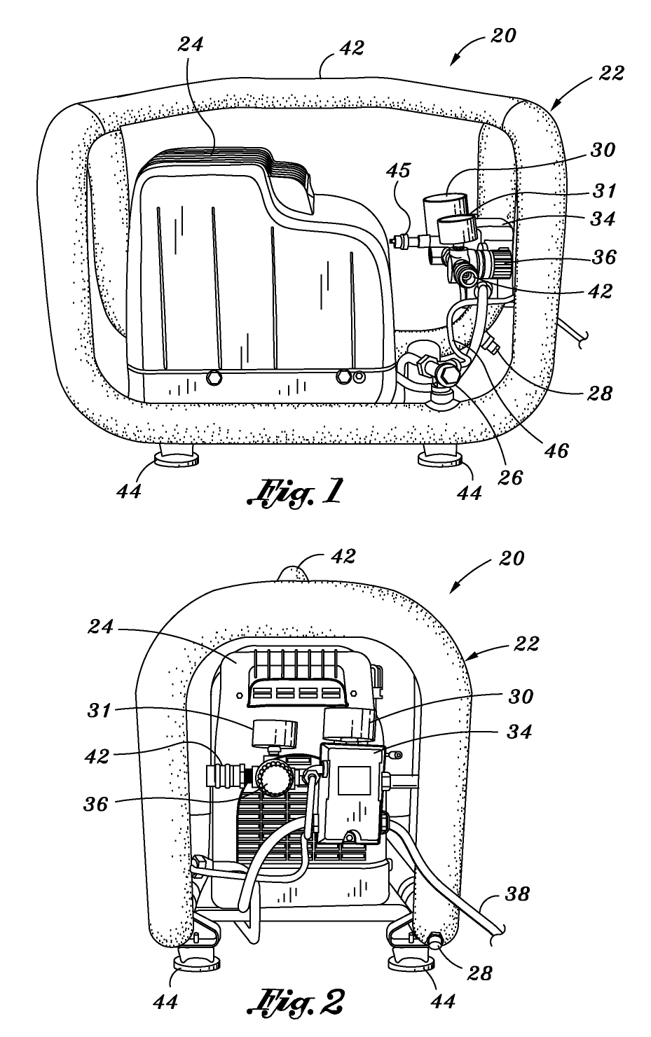

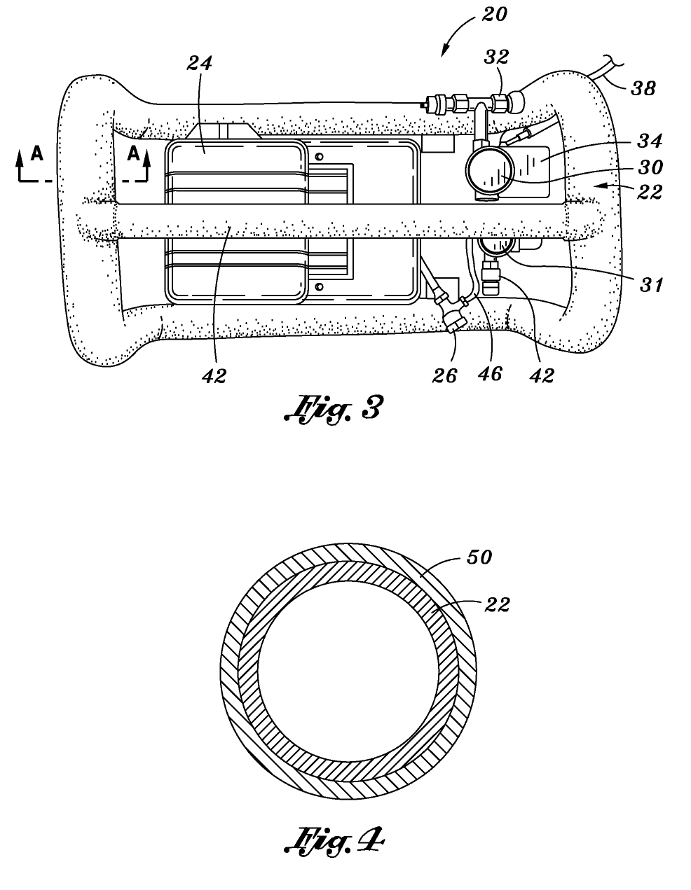

Referring now more particularly to the drawings, there is shown in FIGS. 1-3 a power operated air compressor assembly, generally indicated at 20 which embodies features of the present invention. In general, the power operated air compressor assembly 20 includes a frame structure, generally indicated at 22, which carries a motor and pump housing assembly, generally indicated at 24. The frame structure 22 comprises tubular members connected together to provide a continuous internal chamber or reservoir, capable of holding air that is passed into the frame structure by the compressor unit. One portion of the frame structure may provide a carrying handle 42, conveniently passing over the center of gravity of the assembly, and sized to provide a comfortable handle for moving the assembly about.

The power operated motor and pump housing assembly 24 is comprised of conventional components and, in a preferred embodiment, includes a compressor (not shown separately) which is of the single piston type driven by an electric motor (not shown separately) connected by cable 38 to a power supply. Air that is compressed by the motor and pump housing assembly 24 is sent for storage to the frame structure 22 via an air inlet check valve assembly 26. For extracting compressed air from the frame structure 22, an outlet 32 is provided that passes the compressed air, via an on/off pressure switch assembly 34 to an outlet port or air hose coupler 42, configured for connection to a supply line of a desired device as, for example, a pneumatically operated fastener driving device. Air tank gauge 30 and pressure regulator valve 31 inform the user of the applied pressure, which may be adjusted by a air pressure regulator knob 36 to the desired pressure. A bleed valve or air tank drain plug 28 is provided to release air pressure under contingent event of failure or malfunction. An unloader pipe 46 extends between the pressure switch assembly 34 and the check valve assembly 26. A pressure release valve 45 is adapted to release air pressure in the assembly should the need arise. The compressor assembly may rest on rubber foot pads affixed, preferably, to the frame structure 22.

When the compressor unit is power operated, it is operable to provide a source of air under pressure to the reservoir within the frame structure 22.

The entire assembly 20, including the frame structure 22, is portable and, as shown, the frame structure 22 utilizes, as a main component thereof, elements of tubular stock. The tubular elements are connected to define a continuous internal chamber as the frame structure 22, into which air is pumped by the compressor unit 24, and wherein the air may be held as a supply of compressed air.

Turning now to a novel and inventive aspect of the assembly, it has been determined that advantageous results may be given to the compressor assembly 20 as a whole if the frame structure 22 is coated in a PVC compound as described herein.

In a preferred embodiment of the invention, the apparatus and method followed to apply the PVC layer to the frame structure 22 includes the following steps. A naked frame structure is heated by oven baking for between 5 to 10 minutes in an oven that has been preheated to between 300 to 350 degrees Celsius, and held at that range during the heating process. The frame structure is removed from the oven, and then immediately dipped in a tank of liquid PVC compound, that may have colorant added to give the finished product a desired color. The composition of PVC suitable for this purpose may be high density PVC, but in a preferred embodiment is low density PVC as this provides a lighter weight without significant sacrifice in the advantageous characteristics achieved and identified below. The frame structure may be held in the PVC tank for between 15 to 30 seconds, to permit a layer of PVC to solidify on the frame structure to a thickness of between 2 mm to 9 mm, most preferably 3 mm to 7 mm to produce the advantageous characteristics of thermal insulation, noise attenuation, and overall physical protection.

The frame structure is then removed from the PVC tank, and may be allowed to cure in an enclosure at a temperature of between 100 and 150 degrees Celsius for between 3 to 6 minutes. The frame structure is then removed from the enclosure and allowed to cool to ambient temperature. It has been found that in this way, problems occasioned by the PVC dripping from the frame, not adhering to the frame, and forming uneven thickness over the surface of the frame, are advantageously reduced to an acceptable level, leaving an even single coating, of preferably between 3 and 7 mm. In FIG. 4 there is exemplified a sectional view of the frame structure 22, coated with a layer 50 of PVC.

It will be appreciated that, during this process, the air entrance 26, the air exit 32, and the bleed 28 openings in the tubing of the frame structure 22 are to be blocked with temperature resistant stoppers during the entire process, and then the openings are to be exposed again by cutting the PVC compound with a sharp knife or a drill when the process is complete. After the coating has been applied, points on the frame assembly that will provide support surfaces for the operational units of the compressor 20 may also be exposed with a sharp blade or drill. However, where convenient, the PVC layer may be left undisturbed at points of connection, separated from the applicable unit by a washer if desired. It will be understood that in the resulting structure, essentially the entire tubular frame structure is coated with a layer of PVC.

In an alternative embodiment, the PVC may be sprayed onto the frame structure 22. In this embodiment low density PVC is preferably used, and the frame is coated until the coat thickness is preferably between 3 and 7 mm thick.

When the application of the PVC layer to the frame structure is complete, the operational units of the compressor are connected to the frame structure 22, using bolts, screws, or other suitable means for connection. It has been found that the PVC layer applied to the frame 22, as described, provides numerous positive advantages. First, it will be appreciated that the air contents of the reservoir are continually being vented and refilled. Each time the reservoir 22 is vented, the temperature of the reservoir tends to fall. Conversely, when filled with compressed air, the temperature tends to rise. The application of the PVC layer to the reservoir 22 as described reduces the energy required to operate the device, which, in effect, must act as a heat exchanger during venting and filling, in addition to acting as a compressor. Thus, a useful energy efficiency is achieved by the thermal insulation provided by the reservoir 22.

Next, the application of the PVC layer to the frame achieves a significant vibration attenuation during operation. Not only does the entire assembly tend to vibrate during operation, but resonant frequencies be may be set up between individual components of the assembly and the frame 22. By applying the PVC layer, damping of these vibrations is achieved, reducing the vibration of the device overall, thus reducing both the energy draw and the sound of operation.

Finally, the addition of a PVC layer to the frame reservoir 22 provides an advantageous layer of overall protection to the compressor assembly 20. It will be appreciated that, during the life of a compressor assembly, it will sustain innumerable knocks and bumps. Some of these may have sufficient energy to disable components of the assembly, or even puncture the reservoir itself. By applying a layer of PVC to the outer frame 22, the vibrational impact of knocks and bumps are softened, and the reservoir has acquired an added layer of protection against puncture. Moreover, the compressor assembly will likely be exposed to a corrosive environment during its lifetime. The application of a PVC as described has an advantageously protective effect under such environment.

Thus, the use of a PVC coating as described is highly advantageous in that it is chemically inert, and is water, corrosion, and weather resistant. It has a high strength-to-weight ratio, it is tough, dent-resistant, and is an electrical and thermal insulator, and vibration attenuator. Moreover, it maintains these excellent properties over long periods of time, while the application of PVC as described is relatively inexpensive.

It will be realized, however, that the foregoing preferred specific embodiments have been shown and described for the purpose of illustrating the functional and structural principles of this invention and are subject to change without departure from such principles. Therefore, this invention includes all modifications encompassed within the spirit and scope of the following claims.

We claim:

1. A compressor assembly comprising:
an air compressor for providing a stream of compressed air;
a reservoir for receiving and storing the stream of compressed air, wherein the reservoir comprises a hollow tubular structure defining an enclosed space configured such that the tubular structure forms a frame to generally surround an external perimeter of the compressor assembly, and further
wherein the tubular structure is coated with a layer of PVC.

2. The compressor assembly of claim 1, wherein the PVC coating is between 3 and 7 mm thick.

3. The compressor assembly of claim 1, wherein the PVC coating covers essentially the entire surface of the tubular structure,

4. The compressor assembly of claim 1, wherein the PVC coating is low density PVC.

5. A method of manufacturing a compressor assembly that includes an air compressor for providing a stream of compressed air, comprising;
forming a tubular structure to define a continuous enclosed space, with the tubular structure configured to surround and support internal components of the compressor assembly;
heating an oven;
inserting the tubular structure in the oven to heat the tubular structure;
removing the tubular structure from the oven, and dipping the tubular structure in liquid PVC;
removing the tubular structure from the liquid PVC, and allowing the PVC to cure to solid state; and
connecting the air compressor to the tubular structure.

6. The method of claim 5, wherein heating the oven includes heating the oven to between 300 and 350 Celsius.

7. The method of claim 6, wherein inserting the tubular structure in the oven includes holding the tubular structure in the oven for between 5 and 10 minutes.

8. The method of claim 5, wherein dipping the tubular structure in liquid PVC includes holding the tubular structure in liquid PVC for between 15 and 30 seconds.

9. The method of claim 5, wherein allowing the PVC to cure includes maintaining the tubular structure in an enclosure at above 100 degrees.

10. The method of claim 9, wherein maintaining the tubular structure in an enclosure includes maintaining the tubular structure in an enclosure for more than 3 minutes.

11. The method of claim 5, wherein dipping the tubular structure in liquid PVC includes dipping the structure in low density PVC.
